(19) United States
(12) Patent Application Publication
(10) Pub. No.: US 2010/0315698 A1
(43) Pub. Date: Dec. 16, 2010

(54) Modular ring resonator

(76) Inventor: George J. Dixon, Socorro, NM (US)

Correspondence Address: GEORGE J. DIXON, PO BOX 178, SOCORRO, NM, 87801, US

(21) Appl. No.: 12/082,363

(22) Filed: Apr. 10, 2008

Related U.S. Application Data
(60) Provisional application No. 60/922,781, filed on Apr. 10, 2007.

(51) Int. Cl. G02F 1/35

(52) U.S. Cl. 359/326

(57) ABSTRACT

An optical resonator with an optical mode has a resonator block with and opening. At least one optical component is mounted on a holder that is positioned in the opening to locate the component in the mode of the resonator. The holder is contrained by the resonator block so that the orientation of the component in the plane of the resonator is substantially fixed by the opening. The component is simply aligned in the resonator by rotating the holder in the opening. The resonator block may also have a mirror reference surfaces that automatically aligns a mirror that is pressed against the surface. The resonator has a high degree of optomechanical assembly and facilitates initial component alignment and the interchange of optical components and mirrors.

### CROSS REFERENCE TO RELATED APPLICATION

This application claims priority to U.S. Provisional Patent Application 60/922,781, “Modular Monolithic Ring Laser,” which was filed on Apr. 10, 2007, and which is incorporated herein by reference in its entirety.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of SBIR Contract number NNJ05JA06C awarded by the National Aeronautics and Space Administration.

### TECHNICAL FIELD

The present invention relates generally to lasers and nonlinear optical devices and more specifically to travelling wave optical resonators.

### BACKGROUND

Optical resonators are a necessary component of laser oscillators and many other resonant optical devices. Typically formed from two or more mirrors that are aligned to define a closed optical path for the propagation of light in at least one optical mode, resonators can be divided into two broad categories according to the direction of light propagation. In standing-wave or linear resonators, light travels between the end mirrors of the resonator in two opposing directions, typically interfering to form standing optical waves that are electromagnetic analogs of the vibrational waves in a plucked guitar string. In travelling-wave or ring resonators the light inside the resonator propagates in a single direction.

Ring resonators are typically more complex to manufacture and align than linear resonators but possess unique properties that are advantageous in a number of applications. The absence of a standing wave in the gain medium, for example, facilitates single-frequency laser oscillation at power levels far above those that can be obtained by using a comparable laser material in a linear resonator. Unidirectional ring lasers are also comparatively stable in the presence of external backreflections since the backreflected light propagates in a direction opposite to the propagation direction of the laser.

In most cases, the amplitude and frequency stability of a laser oscillator or other resonant optical device is determined to a large extent by the mechanical stability of the resonator mirrors and the intracavity optical components. Subwavelength variations in the optical path length between the mirrors typically produce frequency excursions in single frequency lasers or significant changes in the output spectrum of multi-frequency devices. Path length variations can also drive relaxation oscillations and other output amplitude instabilities in continuous wave (CW) lasers or produce significant pulse-to-pulse variation in the output of a Q-switched or mode-locked laser. Variations in optical path length inside resonators that are used for nonlinear frequency conversion or as nonlinear oscillators are also deleterious.

For these reasons, it is highly advantageous to design the mechanical components of an optical resonator to maximize their stability in the presence of technical noise that can include temperature fluctuations, mechanical vibration, acoustic vibration, atmospheric pressure fluctuations, electromagnetic fields and other sources of optical path length perturbing energy. It is also advantageous to design mechanical resonator components in such a way that they are easily assembled and aligned and, in almost all cases, it is also advantageous if components within the resonator can be easily replaced or interchanged in the event of component failure or when a need for different performance characteristics arises. Mechanical stability and the ease with which components can be assembled and replaced are competing design constraints that must be balanced in different applications.

If plotted along a line with mechanical stability at one end and ease of component assembly and replacement at the other, conventional resonator designs would be grouped at the two ends of the graph. In other words, designs with a high degree of mechanical stability rarely allow components to be easily replaced.

Some of the most stable resonators are those fabricated from a single crystal with reflective surfaces coated directly on polished surfaces of the crystal. These devices are commonly referred to as monolithic resonators. Monolithic ring resonators are, for example, disclosed in U.S. Pat. No. 4,578,793 issued to T. J. Kane and R. L. Byer on Mar. 25, 1986 and U.S. Pat. No. 5,027,361 issued to W. J. Kozlovsky, C. D. Nabors and R. L. Byer on Jun. 25, 1991. Examples of monolithic linear resonators are described in U.S. Pat. No. 4,739,507 issued to R. L. Byer, G. J. Dixon and T. J. Kane on Apr. 19, 1988, U.S. Pat. No. 5,070,505 issued to G. J. Dixon on Dec. 3, 1991, and U.S. Pat. No. 4,847,851 issued to G. J. Dixon on Jul. 11, 1989.

Other conventional resonator designs achieve high stabilities by affixing the resonator components or subassemblies to a resonator block. Ring resonators with cavity block mounted components are described, for example, in U.S. Pat. No. 6,654,392 issued to M. Arbore and F. Tapos on Nov. 25, 2003 and linear resonators with block-mounted components are described in U.S. Pat. No. 7,068,700 issued to W. R. Rapoport, S. Vetarino and G. Wilson on Jun. 27, 2006 and U.S. Pat. No. 5,923,695 issued to A. B. Patel and M. P. Palombo on Jul. 13, 1999.

At the other end of the stability continuum are conventional designs in which the resonator components are housed in conventional optical mounts that are screwed or otherwise fastened to a baseplate or optical bench. These designs allow components to be interchanged and aligned but are susceptible to all forms of technical noise. They also can have many degrees of alignment freedom that significantly complicate the interchange and alignment of components.

Some improvement in stability may be achieved in a resonators with conventional optical mounts by reducing the size of the resonator, soldering or gluing the component mounts to a rigid baseplate after alignment, or integrating the component mounts and adjustments into a fairly massive cavity block In the Verde line of intracavity-doubled solid-state lasers manufactured by Coherent of Santa Clara, Calif., for example, optical components are attached to small mounts that are aligned and soldered to a ceramic baseplate during initial assembly. Unfortunately, improvements in the stability of Verde lasers are achieved by taking away the possibility of replacing or interchanging cavity optics ouside of the factory where the lasers are assembled. In the MBR line of single frequency ring lasers, also manufactured by Coherent, mirrors and other components are mounted in conventional screw-adjustable optical mounts that are integrated in or attached to a comparatively massive cavity block. While the cavity block offers some immunity to technical noise, the use of conventional screw-adjustable mounts in MBR resonators makes them highly susceptible to technical noise.

### SUMMARY

The present invention is directed to optomechanically stable ring resonators with optical components that are easily inserted, interchanged and aligned. The invention is further directed to methods for interchanging components in a ring resonator.

In accordance with one embodiment of the invention, an optical ring resonator comprises a resonator block with an opening and an optical component mounted on a holder. The holder is positioned in the opening so that light propagating in an optical mode of the resonator passes through the optical component. The holder has an axis and by the opening so that the direction of the axis is predominantly determined by the opening. The alignment of the component is simply accomplished by rotating the component holder about the axis, a process that may be facilitated by having a component with two or more optical surfaces that are parallel to the axis of the holder. Components may be mounted in the holder with the optical surfaces parallel to the axis or the holder may be designed in such a way that components initially mounted in a non-parallel configuration may have their surfaces reoriented in a direction parallel to the axis of the holder by bending or otherwise deforming the component holder. In certain embodiments, the component holder may also have a flange that contacts a surface of the resonator block when the component is positioned in the mode. Contact between the flange and the surface allows the component to be quickly and exactly positioned in the resonator mode and further constrains the direction of the holder axis. Aligned holders may be affixed to the cavity block using a wide range of conventional methods that include threaded fasteners such as machine screws, soldering, welding, silver brazing and adhesive bonding.

The cavity blocks of some embodiments may include one or more mirror reference surfaces for mounting and aligning planar mirrors. The mirror alignment surfaces have well-defined positions and angular orientations with respect to the resonator mode so that a planar mirror, mounted with a portion of the mirror in contact with a mirror reference surface, is automatically aligned during the mounting process. In some embodiments, mirrors may alternatively be mounted in known relationship to the surface of a mirror mount so the mirror is aligned by contact between the mount and a reference surface.

Resonators embodying the invention may include a laser gain medium that is pumped to produce laser oscillation in the resonator, a nonlinear optical material with gain that is pumped to produce oscillation in the resonator, or a nonlinear frequency convertor with an efficiency that is increased by resonating at least one input or output wave in the resonator.

In an alternate embodiment, the invention comprises a ring resonator with an intracavity mode and interchangeable intercavity components. The resonator has a cavity block and at least three mirrors that are aligned to define a mode. It also has a set of at least two optical assemblies, with each assembly having an optical component portion and a circularly-symmetric portion. The assemblies may be interchangeably positioned in a circularly symmetric opening in the cavity block so that the optical component portion of an assembly is positioned in the cavity mode. According to the invention, the optical component portion of an assembly that is positioned in the resonator mode may be simply replaced by the optical component portion of the second assembly by removing the first assembly from the opening in the cavity block, inserting the second assembly into the opening, positioning the optical component portion of the second assembly in the mode, and rotating the second assembly to align it in the resonator. In some embodiments, at least one optical component assembly has a flange that contacts a surface of the cavity block when the component portion of the assembly is positioned in the resonator mode.

In addition to an interchangeable intracavity component, embodiments may have at least one interchangeable cavity mirror that is mounted on a mirror reference surface such that the mirror reference surface substantially aligns the mirror. According to the invention, the operating wavelength or the center of gravity of a group of operating wavelengths, of a laser, parametric oscillator, Raman laser or alternative light oscillator incorporating an interchangeable component resonator embodiment of the invention may be changed by interchanging components or by interchanging components and mirrors.

The invention additionally provides a method for inserting and aligning an optical component in a ring resonator with an intracavity mode, a resonator block, three or more cavity mirrors mounted on the block, and an opening in the block with a circularly symmetric portion, the axis of the circularly symmetric portion being approximately perpendicular to the direction of a resonator mode. According to the invention, the component may be simply inserted and aligned in the cavity by mounting it on an assembly with a barrel, inserting the barrel in the opening, translating the assembly parallel to the axis of the opening so that light in the mode passes through the component and rotating the assembly to align the component in the resonator. In some embodiments, a component may be fabricated to have planar surfaces that are parallel to a line and be mounted on an assembly in such a way that the surfaces are parallel to an axis of the barrel.

### BRIEF DESCRIPTION OF THE DRAWINGS

FIG. 1 is an optical schematic diagram of a ring laser.

FIG. 2 is a sectioned mechanical drawing a modular laser resonator with the optical components of FIG. 1.

FIG. 3 is partially exploded perspective drawing of the modular ring laser illustrated in FIG. 2.

FIG. 4 is a perspective view of a deformable component holder.

FIG. 5 is an optical schematic diagram of an intracavity doubled ring laser.

FIG. 6 is sectioned mechanical drawing of a modular laser resonator with the components of FIG. 5

FIG. 7 is an optical schematic diagram of an optical parametric oscillator.

FIG. 8 is an optical schematic diagram of an external resonant frequency convertor.

### DETAILED DESCRIPTION OF THE INVENTION

Unidirectional ring resonators, in which the intracavity field is a traveling-wave, have several unique and attractive properties when compared to standing-wave, linear-cavity devices. According to A. E. Seigman in Lasers, pp. 532-534 (University Science Books, Sausalito, 1986), “the primary advantage to unidirectional oscillation in a ring laser . . . is that the purely traveling-wave rather than standing-wave operation eliminates spatial hole-burning effects, making the laser medium in effect much more homogeneous. This in turn substantially increases the mode competition between adjacent axial modes, making it possible to pump the laser considerably further above threshold while maintaining single-frequency operation. In addition, because the traveling-wave mode saturates the gain medium uniformly, with no spatial nodes along the axial direction, this mode can extract more power than would otherwise be obtained. The combined effect can be an increase in single-frequency laser output power by more than an order of magnitude compared to what can be obtained using a standing-wave cavity in a typical dye laser example. Similar advantages can be obtained in other lasers, for example, pulsed solid-state lasers, as well.”

Other advantages outlined by Seigman include increased cavity design flexibility, elimination of input feedback effects, and reduced alignment sensitivity. Ring resonators are typically harder to fabricate and align than linear cavities since they typically have more mirrors. Consequently, their use is restricted to single-frequency and other applications where multiple components must be incorporated inside the resonator. Ring resonators are also used in applications where it is desirable to have regions of the resonator in which the resonant mode has different spatial properties. For example, intracavity-doubled solid-state lasers often have a tightly-focused waist in the nonlinear crystal and a larger, nearly-collimated mode in the gain medium and other intracavity elements. These conditions are easily achieved using readily-available spherical optics in a ring resonator. Single-frequency, intracavity-doubled ring lasers also have superior noise properties when compared to multi-mode, linear-cavity devices.

Feedback of the laser output from optical elements outside of the laser cavity is known to destabilize lasers with linear standing-wave resonators. Unidirectional ring lasers are relatively immune to these effects since the feedback does not propagate in the same direction as the oscillating mode. In cases where there is sufficient loss differential between the counterpropagating directions modes, a ring laser is completely immune to feedback from extracavity elements.

To first order, a planar ring resonator is also insensitive to mirror misalignment in the plane of the ring. When cavity mirrors are tilted slightly about an axis that is parallel to the plane of the intracavity mode, the mode will readjust its position and angle to maintain a stable, closed path. With optically-pumped solid-state lasers, for example, this means that small mirror or component misalignments in the plane of the ring can be corrected by translating the pump beam rather than adjusting the mirrors.

The primary disadvantage of a unidirectional ring laser is the decrease in round-trip gain that is associated with single-passing the intracavity gain element. In cases where ultralow-loss (loss <0.02%/surface) resonator mirrors are used, the primary intracavity losses come from the intracavity components and this effect is minimal.

In many of the single-frequency applications in which ring resonators are commonly used, it is desirable to minimize fluctuations in the resonant frequency. These fluctuations are typically caused by small perturbations in the resonator length and are commonly caused by acoustic, thermal and mechanical noise (cumulatively referred to as “technical noise”). These effects may be reduced by optomechanical design and temperature control of the resonator as described in the Background section of this application.

Conventional ring resonator designs offers two alternatives—

1. Stable single-crystal and fixed-component resonators with components that are typically mounted in a temperature-controlled package. These resonators are fabricated in an optical shop using specialized procedures (single-crystal) or factory-aligned using dedicated equipment that is both expensive and complex (fixed-component). The resonator and its components are inaccessible to the end user.
2. Resonators in which individual components are mounted on screw- or micrometer-adjustable mounts. These devices are typically larger than single-crystal and fixed-component designs and are susceptible to technical noise. They are too large to be temperature-controlled. Individual components can be changed and aligned by the end-user. The large number of independent degrees of freedom makes resonator alignment a complex and time-consuming task.

For many applications it is desirable to have a ring resonator with improved stability that is easy to assemble and align. It is also advantageous if one or more of the intracavity components can be easily changed and aligned by the end user. In both cases, it is highly desirable for the stability of the resonator to approach that of single-crystal and fixed component resonators.

In the present invention optomechanical stability is achieved by mounting the cavity optics directly on a resonator block or on optical component holders that are attached to a resonator block. Embodiments of the invention have at least one intracavity component that is mounted on an optical assembly that is positioned in an opening in the cavity block. Advantageously, the opening and the assembly have circularly-symmetric portions that interact to constrain the direction of the assembly when it is positioned in the hole in such a way that the intracavity component can be aligned by rotating the assembly. The rotational alignment operation is much easier than three-axis alignment operations in a conventional resonator and, in most cases, can be performed by a worker of average skill without using tools.

The resonator blocks in certain embodiments also have one or more mirror reference surfaces for mounting cavity mirrors. The angle and position of the mirror reference surfaces are such that a planar mirror is automatically aligned when it is mounted on a surface and a curved mirror can be aligned by translating it in a plane that is parallel to the surface on which it is mounted. Aligned optics mounts and retaining plates are typically attached to the cavity block using screws or affixed to the resonator block with solder, glue or other conventional fashion and the response of the assembled cavity to technical noise is principally determined by the response of the cavity block.

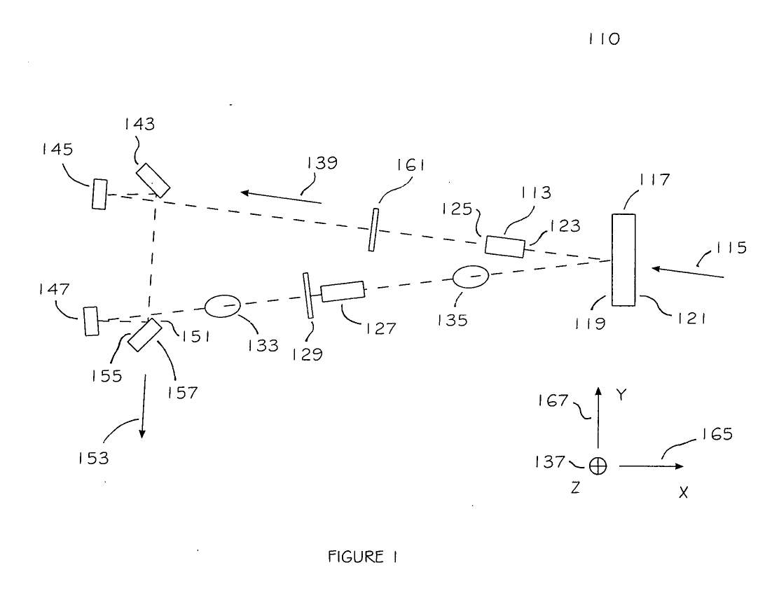

The invention may be embodied in many forms with intracavity components and mirror reflectivities for operation, for example, as laser oscillators, optical parameteric oscillators, Raman oscillators, resonant nonlinear frequency convertors and other resonant optical devices. In one embodiment, intracavity components and mirrors are configured for operation as a single-frequency, diode-pumped laser 110 as illustrated in the optical schematic diagram of FIG. 1. In the laser 110, a crystal of yttrium vanadate (Nd:YVO₄) 113 doped with 0.7% neodymium is optically pumped by the output of a diode laser that propagates in the direction 115 and is focused through the pump mirror 117 by a pump optical system (not shown). The intracavity surface 119 of the pump mirror 117 is typically coated for high reflectivity (reflectivity >99.7%) at the laser operating wavelength of 1064 nm and high transmission (transmission greater than 90%) at the pump wavelength of 809 nm. The other surface 121 of the pump mirror is antireflection-coated (transmission >99%) at the pump wavelength. The surfaces 123 and 125 of the Nd:YVO₄ crystal 113 are approximately plane parallel. The pump surface 123 is typically antireflection-coated at 1064 nm and 809 nm while the other gain crystal surface 125 is typically antireflection at 1064 nm.

Unidirectional oscillation of the laser is achieved by through the combined action of the Faraday rotator 127, the polarization rotator 129, and the polarizers 133 and 135. In the laser 110, the conventional Faraday rotator 127 is a cylindrical crystal of terbium gallium garnet (TGG) located in the cylindrical bore of Neodymium permanent magnet. Both surfaces of the TGG are antireflection-coated at 1064 nm. The polarization rotator 129 is a zero-order waveplate at 1064 nm or an optically active quartz polarization rotator that is oriented in such a way that the net polarization rotation of a linearly polarized beam passing through the polarization rotator 129 and the Faraday rotator 127 in one direction is approximately zero while the polarization rotation experienced by a beam travelling the opposite direction is non-zero. The surfaces of the polarization rotator are typically antireflection coated at 1064 nm. The polarizers 133 and 135 are typically Brewster plates with plane parallel surfaces angled so that a beam that is linearly polarized in the Z direction 137 experiences minimum loss at 1064 nm in passing through the two polarizers 133 and 135. The orientation of the polarization rotator 129 is adjusted so the light polarized in the perpendicular direction 137 and propagating in a counterclockwise direction 139 experiences less loss when passing through the polarizers 133 and 135, the polarization rotator 129 and the Faraday rotator 127 than Z-polarized light propagating in the opposite, clockwise direction.

The bending mirror 143 and the curved mirrors 145 and 147 are coated for high reflectivity at 1064 nm on their intracavity surfaces while the output mirror 151 is coated to couple light out of the resonator as an output beam 153. The reflectivity of the intracavity surface of the output coupler 151 is typically between 80% and 99.7%, the exact value being determined by the round trip gain and loss of the laser cavity. The other surface 157 of the output mirror 151 is antireflection coated at 1064 nm. The thin, uncoated etalon 161 is oriented to restrict the longitudinal mode spectrum of the laser.

To achieve stable unidirectional oscillation in the direction 139, the surfaces of the gain crystal 113, the etalon 161, the polarization rotator 129 and the gain crystal 127 are typically rotated about axes in a plane containing the X axis 165 and the Y axis 167. The angles and thicknesses of the components 113, 129, 161, 127 and the thicknesses of the Brewster plates 135 and 133 are chosen in such a way that the net deviation of the intracavity mode from the XY plane in travelling in the counterclockwise direction 139 from the Brewster plate 133 to the etalon 161 is approximately zero.

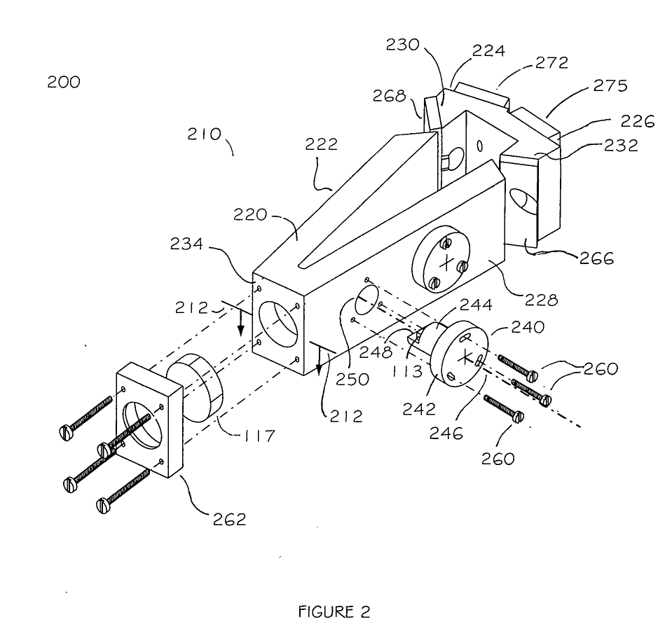

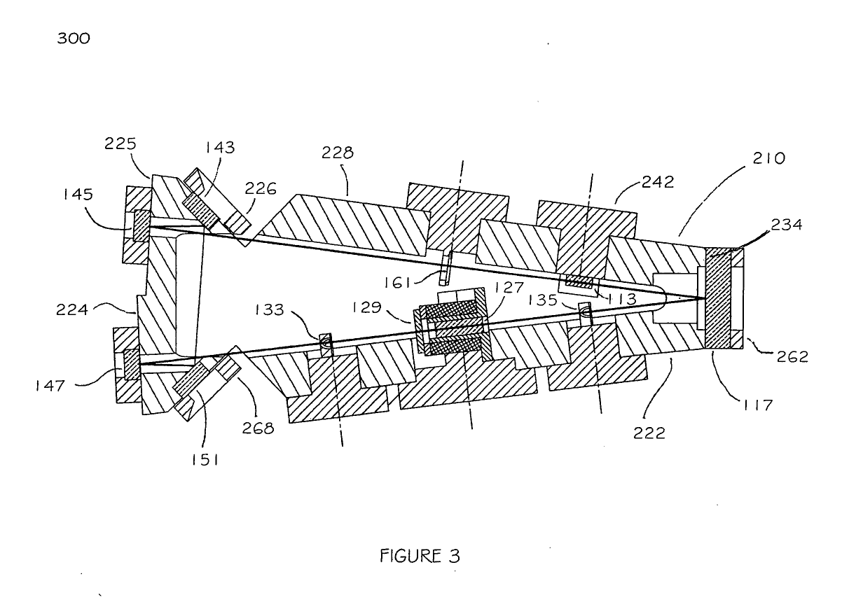

According to the invention, the intracavity components of the laser 110 may be attached to optical component holders that are positioned to transmit light propagating in a mode of the laser as illustrated in the partially-exploded perspective view 200 of the laser resonator 210 as shown in FIG. 2 and the sectional view 300 of the laser resonator 210 as shown in FIG. 3. The sectional view of FIG. 3 is a top view of the resonator section that is formed by slicing the resonator along the line 212 in FIG. 2.

In the partially-exploded perspective view 200 of the laser resonator 210, the pump mirror 117 and the gain crystal 113 have been separated from the resonator block 220 in order to illustrate certain features of the invention. The resonator block is approximately 37.5 millimeters thick in the direction perpendicular to the plane of the ring and can be machined from any suitable structural material including, for example, low expansion steels such as Invar, stainless steel, aluminum and machinable ceramics. In the resonator 210, the external surfaces 222, 224, 226, 228, 230, 232 and 234 are fabricated to be approximately perpendicular to the plane of the ring and precisely positioned with respect to a reference point in the plane of the ring. Errors in perpendicularity and positioning are determined by the accuracy of the machining process used to fabricate the resonator block and such errors can be held within acceptable limits if the block is fabricated by a machinist of ordinary skill using a conventional milling machine and indexing head or a conventional computer numerically controlled (CNC) machining station. Advantageously, the surfaces of the resonator block 220 and the holes in the surfaces may be fabricated with a high degree of precision by machining or casting a piece that roughly approximates the finished resonator block, mounting the piece in the horizontal indexing head of a conventional five-axis CNC milling station and machining the reference surfaces without removing the piece from the chuck.

In the resonator 210, the gain crystal 113 is mounted on an optical component holder 240 that has a flanged portion 242 and a barrel 244. The barrel 244 is circularly symmetric about the axis 246. The gain crystal 113 is mounted on a cutout portion of the barrel 248 in such a way that the coated surfaces of the gain crystal are approximately parallel to the axis 246. When the resonator 220 is fully assembled, the barrel 244 passes through the circular opening 250 and the inner surface of the flange contacts the resonator block surface 228. The barrel 244 and the opening 250 are sized in such a way that the direction of the barrel axis 246 is principally determined by walls of the opening. In the resonator 210, the barrel direction is further constrained by contact between the inner surface of the flange 242 and the resonator block surface 228.

When the barrel 244 is in the opening 250 and the inner surface of the flange 242 is in contact with the surface 228, the gain crystal is approximately aligned in the plane of the resonator mode. Because the resonator is a ring resonator, small misalignments in the plane of the resonant mode (the XY plane in FIG. 1) do not misalign the resonator. Instead, the errors cause the resonator mode to move slightly in the plane of the resonator. This motion typically has little effect on the operation of the laser or, in cases where it does, the problem can be easily compensated by slight changes in the direction of the pump beam.

Alignment of the gain crystal 113 in the plane perpendicular to the plane of the ring is accomplished by rotating the component holder 242 about the axis 246. In an accurately-machined embodiment, the rotational alignment process can be precisely executed without the benefit of tools or other fixtures. In the resonator 210, the gain crystal 113, etalon 161, Brewster plates 133, 135, and an assembly containing the Faraday rotator, 127 and polarization rotator 129 are all mounted on optical component holders that are similar to the component holder 242 and are aligned by rotation about an axis.

In the resonator 210, component holders such as the component holder 242 are fastened to the cavity block with machine screws 260 after they are positioned and aligned in the cavity. In other embodiments, the component holders may be affixed to the cavity block using alternative methods that include but are not limited to soldering, welding, brazing and adhesive bonding. Different methods may be employed within a single resonator. For example, holders with components that are designed to be replaced or interchanged for other components may be affixed to a cavity block using screws or other removable fasteners while holders with permanently mounted components may be attached to a cavity block by more permanent methods such as soldering or adhesive bonding.

The mirrors that form the resonator 210 are pressed against precisely machined mirror surfaces of the resonator block 220. In the perspective view 200 the outer portion of the planar pump mirror 117 is pressed against the mirror reference surface 234 by the pump mirror cover plate 262 and is automatically aligned by the surface 234. The bending mirrors 143 and the output mirror 151 are pressed against countersunk mirror reference surfaces in the angled surfaces 230, 232 of the resonator block 220 by mirror plates 266, 268 and aligned by the countersunk reference surfaces.

The curved resonator mirrors 145 and 147 are pressed against the reference surfaces 224 and 226 by the mirror plates 272 and 275. The cavity is initially aligned by translating the curved mirrors in directions parallel to the surfaces on which they are mounted and the size of the intracavity mode in the gain crystal may be optimized by inserting shims between the curved mirrors 145, 147 and the reference surfaces 224, 226 on which they are mounted.

In the resonator 210, the mirrors are held against the reference surfaces on which they are mounted by fastening the mirror plates 262, 266, 268, 272 and 275 to the resonator block with machine screws. In alternative embodiments one or more of the mirrors may be affixed to the resonator block by adhesive bonding, soldering or other conventional method. Mirrors may also be affixed to plates with the mirror surfaces parallel to and separated from the surfaces of the plates and aligned by contact between the surface of a plate and a mirror reference surface.

Optical components can be mounted on the optical component holders using conventional methods that include pressing them against the body of the holder with a screwed cover plate and affixing them to the holder with adhesive bonding, soldering or other conventional mounting techniques. Advantageously, the methods used to affix the components to the component holders and the methods used to fasten or affix the component holders to the resonator block can decrease the susceptibility of the components to vibration and other forms of technical noise. In the ideal case, the techniques employed are such that the assembled resonator responds to noise inputs as a single piece having the combined mass of the cavity block and component mounts.

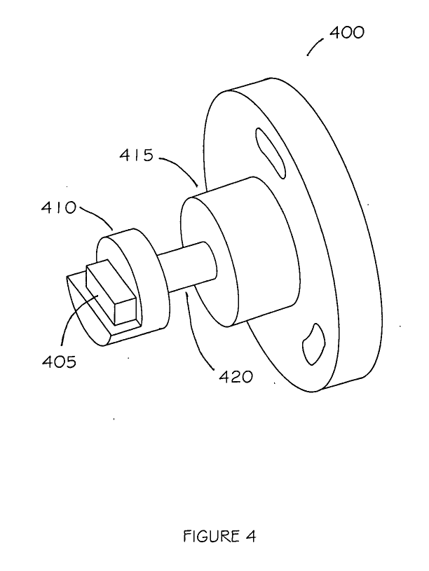

In addition to the component mount designs illustrated in FIG. 2 and FIG. 3, alternative embodiments may have component mounts that are designed to meet specialized requirements. A component mount for a gain crystal, for example, may be designed with fluid channels and connections that allow heat to be removed from the crystal by flowing water or another coolant in the channel. Alignment of components with planar optical surfaces is facilitated by orienting the surfaces so that they are parallel to the rotational axis of the mount. This may be achieved by machining a mechanical reference into the mount, carefully aligning the component before it is fastened or affixed to the mount or, in some cases, by bending or otherwise deforming the mount. In the deformable component holder 400 that is schematically illustrated in FIG. 4, an optical component 405 with plane surfaces is attached to a component mounting portion 410 of the holder 400. The component mounting portion 410 is separated from the barrel 415 of the mount, for example, by a rod, a tube, or other small diameter connector 420. During initial alignment, the surfaces of the optical component 405 are made parallel to the axis of the barrel by bending the rod or small diameter region. If the size and material of the connector 420 are chosen appropriately, the surfaces of a component that is aligned by bending the holder will permanently remain parallel to the axis of the barrel.

In some embodiments the resonator illustrated in FIG. 1, FIG. 2 and FIG. 3 may have components that are coated to facilitate changing the operating wavelength of the laser or the center of gravity of a group of operating wavelengths in cases where the laser operates at two or more wavelengths. When pumped with the output of a diode laser near 809 nm, Nd:YVO₄ typically has sufficient gain for laser oscillation on transitions near 920 nm, 1064 nm and 1342 nm. The resonator 210 may be configured for interchangeable operation at two of the wavelengths by interchanging a few components by appropriately specifying the coatings on the intracavity components and the curved end mirrors. For example, changing the laser oscillation wavelength from 1064 nm to 1342 nm can be facilitated by coating the curved mirrors 145, 147 for high reflectivity at 1064 nm and 1342 nm and coating the polished surfaces of the Faraday rotator 127 and the gain crystal 113 with dual band antireflection coatings at 1064 nm and 1342 nm. The dual band coatings on these surfaces would have little effect on operation at 1064 nm and operation at 1342 nm could be easily achieved by replacing the flat mirrors. For operation at 1342 nm, the bending mirror 143 would be replaced with an optic coated for high reflectivity at 1342 nm and high transmission at 1064 nm, the output mirror 152 would be replaced with an optic coated for high transmission at 1064 nm and a transmission of 0.3%-10% at 1342 nm and the pump mirror 117 would be replaced with a mirror that was antireflection-coated at 809 nm on the outer surface 121 and high transmission at 810 nm and high reflectivity at 1342 on the intracavity surface 119. Because the flat mirrors 117, 151, and 143 are automatically aligned by contact with mirror reference surfaces in the resonator 210, the mirrors could be quickly and easily changed by unscrewing the cover plates 266, 268 and 262 replacing the mirrors with optics coated for 1342 nm operation and refastening the plates to the resonator so the 1342 nm optics were pressed against the mirror surfaces 226, 230 and 234.

The center of gravity of the operating wavelength of the laser in FIG. 1, FIG. 2 and FIG. 3 could also be changed from 1064 nm to 1047 by replacing the Nd:YVO₄ gain crystal 113 with a similarly-shaped Nd-doped yttrium lithium fluoride (Nd:YLF) crystal coated for laser operation at 1047 nm and pumping it near 792 nm or 795 nm. Advantageously, the Nd:YLF crystal would be mounted on a component holder similar to the component holder 240 and the conversion from 1064 nm operation to 1047 nm operation could be easily accomplished by removing the Nd:YVO₄ component holder from the resonator block 220, inserting the Nd:YLF component holder into the block and aligning the Nd:YLF crystal in the resonator by rotating the component holder.

While the component holders in the resonator 220, have flanges that contact surfaces of the resonator block to position the optical component in the resonator and constrain the axis direction of the holder other embodiments have component holders without flanges. In an unflanged holder, the direction of the component holder is fixed by an opening in the resonator block and the holder is held in place using at least one fastener that is screwed into the resonator block and contacts the holder or by alternative methods that include welding, brazing, soldering and adhesive bonding.

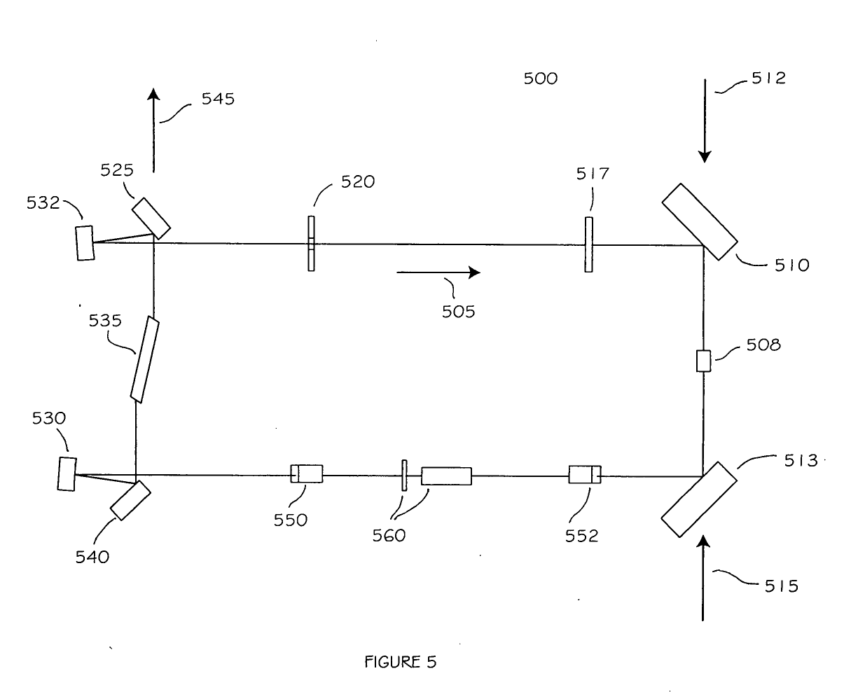

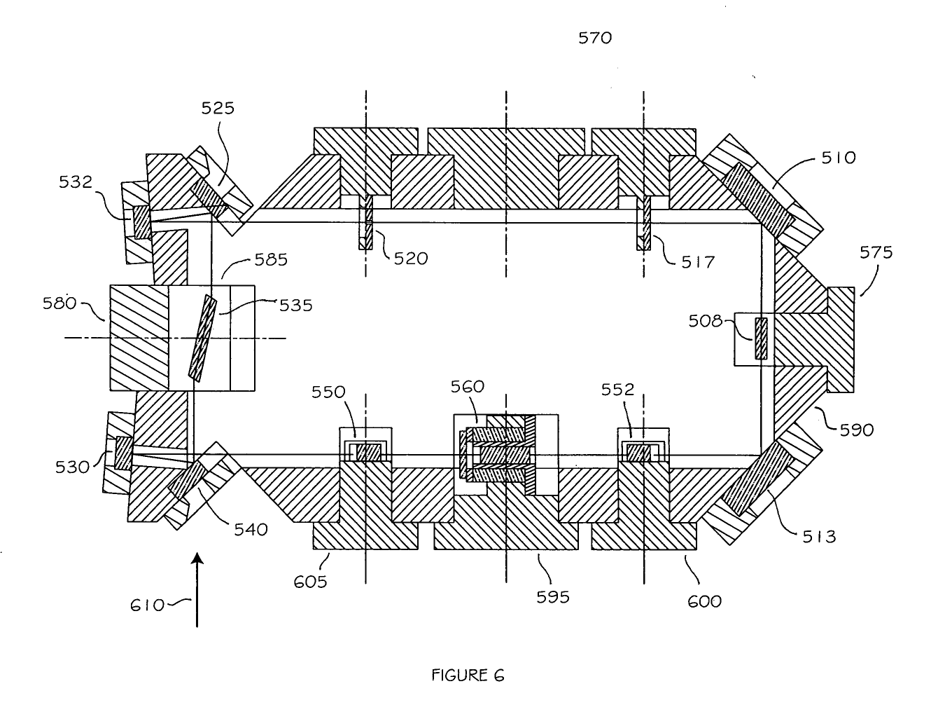

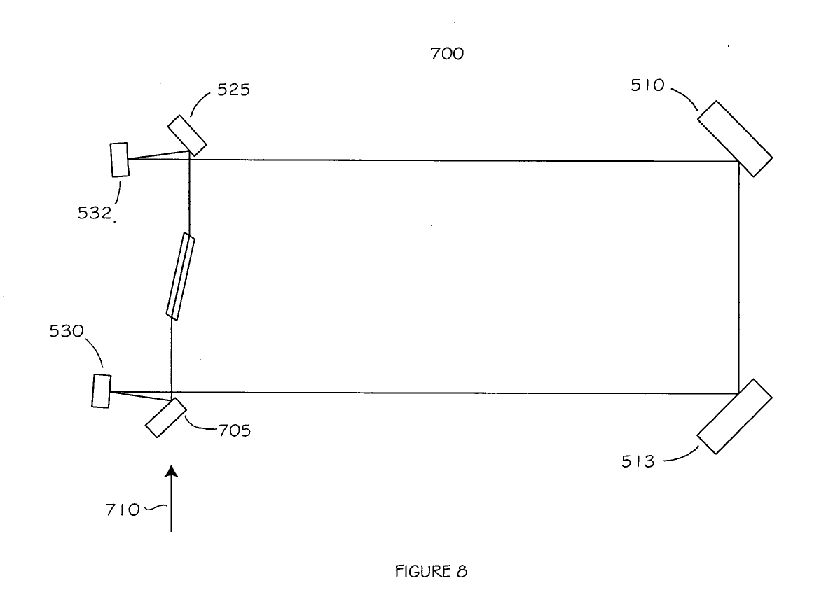

In another embodiment of the invention, illustrated in FIG. 5 thru FIG. 8, intracavity components and mirrors are mounted on a resonator embodying features of the invention to facilitate operation as an intracavity-doubled laser, an optical parametric oscillator and a resonantly enhanced frequency doubler. FIG. 5 is an optical schematic diagram and FIG. 6 is a sectioned mechanical drawing of an intracavity-doubled Nd:YVO₄ laser 500 embodying features of the invention.

Referring to FIG. 5, the intracavity doubled laser oscillates in the clockwise direction 505 and derives optical gain from an Nd:YVO₄ gain crystal 508 that is doped with 0.1% neodymium. The gain crystal 508 is pumped near 809 nm by a beam that is focused into the gain crystal 508 through one of the pump mirrors 510 along the direction 512. Optionally, a second pump beam may be focused into the crystal 508 through the pump mirror 513 along the path 515. The length and cross sectional dimensions of the Nd:YVO₄ gain crystal are chosen to efficiently absorb energy from the pump beam(s) and dissipate excess heat. The surfaces of the gain crystal 508 are polished and coated with dual-band antireflection coatings at 809 nm and 1064 nm.

The intracavity surfaces of the plane pump mirrors 513 and 510 are coated for high reflectivity at 1064 and 1520 nm and high transmission at 809 nm while the other surfaces of the pump mirror 513 and 510 are coated for high transmission at 809 nm. The tilted etalon 517 and aperture 520 partially define the longitudinal and transverse mode of the light field within the laser. The bending mirror 540 and the curved mirrors 532 are coated for high reflectivity at 1064 nm and 1520 nm and the radius of curvature of the mirrors chosen to assure cavity stability and produce a tight beam waist in the periodically poled lithium niobate (PPLN) crystal 535. A representative PPLN crystal 535 is poled for second harmonic generation at a fundamental wavelength of 1064 nm using d₃₃, is approximately 20 mm in length, and is oriented with the c-axis normal to the plane defined by of the intracavity mode as it passes between the bending mirrors 525,540 through the PPLN crystal (perpendicular to the plane of the illustration in FIG. 5). Both surfaces of the PPLN crystal 535 are coated for dual band antireflection at 1064 nm and 532 nm. The green, 532 nm light produced by second harmonic generation of the intracavity field at 1064 nm exits the cavity through the output mirror 525 in the direction 545. The planar output mirror 525 is coated for high reflectivity at 1064 nm and high transmission at 532 nm on the intracavity surface and antireflection coated at 532 nm on the other surface. The Brewster angles rods 550 and 552 and the TGG unidirectional device 560 are adjusted so that the laser oscillates in the clockwise direction 505 and the intracavity mode is planar in the portion of the resonator between the etalon 517 and the Brewster rod 550 containing the PPLN crystal 535.

The components of the intracavity doubled laser 500 may be mounted in a resonator embodying features of the invention as illustrated in the sectional top view of FIG. 6. In the FIG. 6 illustration, the resonator assembly 570 has been cut in the plane defined by the portion of the resonant mode passing the PPLN crystal 535 between the Brewster rod 550 and the etalon 517. In the resonator assembly, the gain crystal 508 is attached to the flanged component holder 575 using thermally conductive epoxy or solder so that the surfaces of the gain crystal 508 are parallel to the axis of the holder 575. In alternative embodiments, the gain crystal may be attached to the holder using other conventional methods that facilitate heat transfer from the crystal. In these embodiments, the component holder 575 can also have channels and fittings for coolant flow or, alternatively, it can have a heat sink on its outer surface or be attached to a heat sink with a thermal bridge.

The PPLN crystal 535 is mounted on a heater 585 that is attached to a flanged component holder 580. The heater 585 can be a simple resistance heater, a thermoelectric heater or another type of conventional heater. The temperature of the crystal is measured using a thermistor or another type of conventional sensor that is mounted near the crystal on the hot side of the heater and the crystal temperature is controlled using a conventional electronic feedback controller.

The output mirror 525, the bending mirror 540 and the pump mirrors 510, 513 are automatically aligned by pressing them against mirror reference surfaces on the resonator block using mirror cover plates as previously described. In alternative embodiments, the mirrors 525, 540, 510 and 513 can be affixed directly to by soldering, adhesive bonding or an alternative bonding technique. The curved mirrors 530 and 532 are also pressed against mirror reference surfaces of the cavity block by mirror cover plates. The other intracavity optical components are mounted on flanged component holders that are fastened to the cavity block using machine screws.

In order to change the function and operating wavelength of the resonator 570, different PPLN crystals, intracavity optics and mirrors can be used. PPLN crystals having the same physical dimensions as the PPLN crystal 535 but different domain thicknesses are interchanged with the PPLN crystal 535 to phase-match different nonlinear processes and obtain different output wavelengths. The interchange of components is facilitated by mounting them on component holders or pressing them against mirror reference surfaces on the resonator block. More specifically, planar mirrors that are pressed against the resonator block are automatically aligned and optics mounted on component holders are simply aligned by rotating the holders.

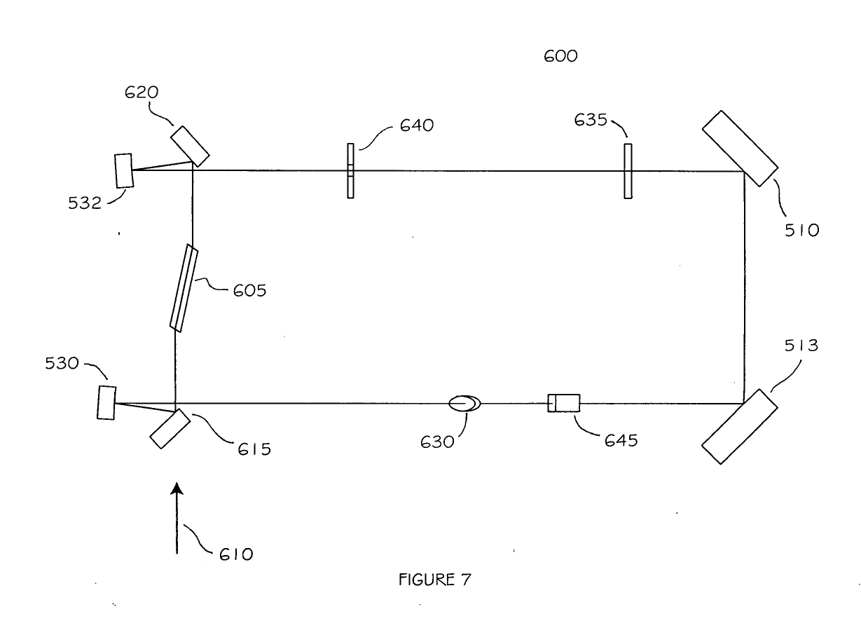

FIG. 7 is a schematic optical diagram illustrating components that can be used in the resonator 570 to obtain optical parametric oscillation near 1520 nm and 3530 nm. In the optical parameteric oscillator (OPO) 600, the PPLN crystal 535 and holder have been replaced with a PPLN crystal 605 with a domain thickness suitable for optical parametric generation of 3530 nm and 1520 nm light with a 1064 nm pump. Because they are coated for high reflectivity at 1520 and 1064 nm, the curved mirrors 530, 532 and the pump mirrors 513, 510 of the intracavity doubled laser 500 can be used in the OPO 600.

The OPO is pumped with a 1064 nm beam 610 that is focused into the PPLN crystal through the mirror 615. The intracavity surface of the mirror 615 is coated for high transmission at 1064 nm and high reflectivity at 1520 nm and the outer surface is AR coated at 1064 nm. The mid-IR output of the OPO exits the cavity through a sapphire mirror with an intracavity surface coated for high reflectivity at 1520 nm and high transmission near 3540 nm and an outer surface that is AR coated at 3540 nm. The wavelength of the OPO is tuned by changing the temperature of the PPLN crystal and by adjusting the orientation of the Lyot filter 630 and the etalon 635. The aperture 640 facilitates operation in a single transverse mode and the Brewster rod 645 compensates for the beam displacement of the Lyot filter.

The intracavity doubled laser 500 is converted to the OPO 600 in the resonator 570 by interchanging the nonlinear crystal 605 and the nonlinear crystal 535, replacing the mirror 525 with the mirror 620, replacing the mirror 540 with mirror 615, interchanging the unidirectional device 560 and the Lyot filter 630, and removing the gain crystal 508 and the Brewster rod 550 from the resonator. This conversion may be simply and quickly performed because the mirrors 615 and 620 are automatically aligned by contact with mirror reference surfaces and the Lyot filter 630 and PPLN crystal 605 are simply aligned by rotating the component holders on which they are mounted.

The intracavity doubled laser 500 may also be converted to the resonant external frequency doubler 700 illustrated in FIG. 7. In this case, all intracavity components except the PPLN crystal 535 are removed from the resonator and the mirror 540 is replaced by the coupling mirror 705. The intracavity surface of the coupling mirror 705 is coated with a transmission at 1064 nm in the range of 0.3% to 10% that is approximately equal to the sum of the linear and nonlinear 1064 nm losses of the operating intracavity doubler. The outer surface of the coupling mirror 705 is antireflection coated at 1064 nm. Resonant harmonic generation is accomplished by adjusting the PPLN temperature for second harmonic generation at a fundamental wavelength of 1064 nm and mode-matching a single frequency 1064 nm input beam 710 to a mode of the resonator through the mirror 705.

In view of the many possible embodiments to which the principles of the present invention may be applied, it should be recognized that the embodiments described herein with respect to the drawing figures are meant to be illustrative only and should not be taken as limiting the scope of the invention. For example, the invention provides for intracavity modulators, including acousto-optic or electro-optic Q-switches and mode-lockers, to be mounted on optical component holders and inserted/removed from a resonator block to switch between CW and pulsed laser oscillation. Those skilled in the resonator and laser design arts will realize that the invention may be practiced using resonator designs other than those described in this document and illustrated in FIG. 1 through FIG. 8.

I claim:

1. An optical ring resonator with at least one resonant optical mode, the resonator comprising:
a resonator block with an opening;
an optical component holder with an axis; and
an optical component mounted on the optical component holder,
the component holder passing through the opening in the resonator block so that direction of the axis is predominantly determined by the opening and the optical component is positioned to transmit light in the resonant optical mode.

2. The optical resonator of claim 1 wherein the component is aligned by rotating the component holder about the axis.

3. The optical resonator of claim 1 wherein the optical component has at least two optical surfaces and the surfaces are substantially parallel to the axis of the holder.

4. The optical resonator of claim 3 wherein the surfaces of the component are made substantially parallel to the axis by deforming the optical component holder.

5. The optical resonator of claim 1 wherein the component holder has a flange that contacts a surface of the resonator block.

6. The optical resonator of claim 1 wherein the component holder is affixed to the resonator block.

7. The optical resonator of claim 1 wherein the resonator further comprises a laser gain medium that is pumped to have optical gain, the laser gain medium being positioned in the mode so that laser oscillation occurs within the resonator.

8. The optical resonator of claim 1 further comprising a nonlinear material that is pumped to have optical gain, the nonlinear gain material being positioned in the mode so that light oscillation occurs within the resonator.

9. The optical resonator of claim 1 further comprising a nonlinear frequency convertor positioned in the mode.

10. The optical resonator of claim 1 further comprising a mirror alignment surface and a resonator mirror, the resonator mirror being substantially aligned by the mirror alignment surface.

11. The optical resonator of claim 10 wherein a portion of the resonator mirror contacts the alignment surface.

12. The optical resonator of claim 10 further comprising a mirror holder, the mirror being mounted in the mirror holder and a portion of the mirror holder contacting the alignment surface.

13. The optical resonator of claim 1 wherein the cavity block is a single piece.

14. The optical resonator of claim 1 wherein the cavity block is formed by joining two or more pieces.

15. An optical ring resonator with at least one intracavity mode and interchangeable intracavity components, the resonator comprising:
a resonator block with a circularly symmetric opening;
three or more mirrors mounted on the resonator block and aligned to define the mode; and
two or more optical assemblies, each optical assembly having an optical component portion and a circularly symmetric portion such that the component portion of an optical assembly is positioned for interaction with light in the mode by inserting the circularly symmetric portion of the assembly in the opening and the optical component portion is aligned by rotating the assembly
wherein the optical component portion of a first optical assembly positioned in the resonator and the optical component portion of a second optical assembly are interchanged by removing the first assembly from the opening, inserting the second assembly into the opening, positioning the second assembly in the opening so that light in the mode traverses the optical component portion of the second assembly, and rotating the second assembly to align the optical component portion of the second assembly.

16. The optical ring resonator of claim 15 further comprising a flange reference surface on the resonator block, at least one optical assembly having a flange that contacts the flange reference surface when the component portion of an optical assembly is positioned so that light in the mode traverses the optical component portion.

17. The optical ring resonator of claim 15 further comprising:
a mirror reference surface on the resonator block;
a cavity mirror that is mounted on and substantially aligned by the mirror reference surface; and
a replacement mirror,
wherein the cavity mirror and the replacement mirror are interchanged by demounting the cavity mirror from the resonator block and mounting the replacement mirror on the reference surface of the resonator block, the replacement mirror being substantially aligned by the reference surface of the block.

18. The optical ring resonator of claim 15 wherein the resonator is a light oscillator that oscillates at one or more wavelengths, the wavelengths having a center of gravity that is changed by interchanging the optical component assemblies.

19. The optical ring resonator of claim 15 wherein the resonator is a light oscillator that oscillates at one or more wavelengths, the wavelengths having a center of gravity that is changed by interchanging at the optical component assemblies and at least the cavity mirror.

20. A method of inserting and aligning an optical component in a ring resonator with at least one intracavity mode, the ring resonator comprising a resonator block, three or more mirrors mounted on the resonator block, an opening in the resonator block with a circularly symmetric portion and an axis that is substantially perpendicular to the direction of the mode, the method comprising the steps of:
mounting the optical component on an assembly with a barrel;
inserting the barrel in the opening;
translating the assembly in a direction substantially parallel to the axis of the opening so that light propagating in the mode passes through the optical component; and
rotating the assembly to align the optical component in the resonator.
